(19) United States
(12) Patent Application Publication
(10) Pub. No.: US 2003/0187873 A1
(43) Pub. Date: Oct. 2, 2003

(54) Secure paperless method and apparatus for managing a forensic chain of custody

(76) Inventors: Daniel Paffe, Austin, TX (US); Deanna Reader, Austin, TX (US); Jack Zaun, Austin, TX (US); John Blomquist, Austin, TX (US)

Correspondence Address: Janis E. Clements, Jeffrey D. Jacobs, 1104 Nueces Street, Austin, TX, 78701, US

(21) Appl. No.: 10/114,708

(22) Filed: Apr. 2, 2002

(51) Int. Cl. G06F 17/00; G06F 7/00; G06F 17/21

(52) U.S. Cl. 707/104.1; 715/531

(57) ABSTRACT

In accordance with one aspect of the present invention, a secure paperless method for managing a forensic chain of custody comprises collecting forensic data and personal data relating to a person, entering the forensic data and the personal data into a database, and creating a documentary summary of the forensic data and the personal data. In accordance with another aspect of the present invention, a computer system manages a forensic chain of custody. The computer system includes a processor subsystem operative to execute instructions and a memory subsystem coupled to the processor subsystem. The memory subsystem contains a set of instructions that when executed in the processor system causes the processor system to perform the aforementioned method. In accordance with another aspect of the present invention, a computer-readable medium contains a set of instructions that when executed in a processor system causes the processor system to perform the aforementioned method.

### TECHNICAL FIELD OF THE INVENTION

The present invention relates to forensic testing, and more particularly to implementing a forensic chain of custody.

### BACKGROUND OF THE INVENTION

Forensic testing is a growing technological area. Recent legislative and judicial changes have only increased the rate of this growth. However, as the number of tests available to scientists continues to grow, and as the number of companies and law enforcement agencies demanding tests continues to grow, managing samples and maintaining a retraceable chain of custody become problematic. Samples may be obtained in a correctional facility or at an employment site (such as an industrial, agricultural, or military site) that is distant from any medical facilities, and then transported to a laboratory for testing. Maintaining certainty that a sample belongs to the person from whom it was obtained is further complicated by the number of intermediaries, the harsh laboratory conditions in which samples are stored and tested (giving rise to the possibility that laboratory accidents or spills may destroy paperwork), and marginally-legible handwriting. In a field where precision and accuracy can have tremendous impact on life-changing events such as obtaining or losing a job or government contract, a better way of keeping track of samples must be devised.

### BRIEF DESCRIPTION OF THE DRAWINGS

FIG. 1 is a flowchart representing a secure paperless method for managing a forensic chain of custody.

FIG. 2 is a flowchart representing a client-side process of a secure paperless method for managing a forensic chain of custody, in accordance with one embodiment of the present invention.

FIG. 3A and FIG. 3B are a representation of a form that may be presented to a user within the client-side process of FIG. 2.

FIG. 4 is a flowchart representing a server-side process of a secure paperless method for managing a forensic chain of custody, in accordance with one embodiment of the present invention.

FIG. 5 is a representation of a documentary summary that may be presented to a user within the server-side process of FIG. 4.

FIG. 6 is a schematic drawing depicting a computer system 40, in accordance with one embodiment of the present invention.

FIG. 7 is a schematic drawing depicting a computer-readable medium that contains a set of instructions, in accordance with a first embodiment of the present invention.

### DETAILED DESCRIPTION OF EXEMPLARY EMBODIMENTS

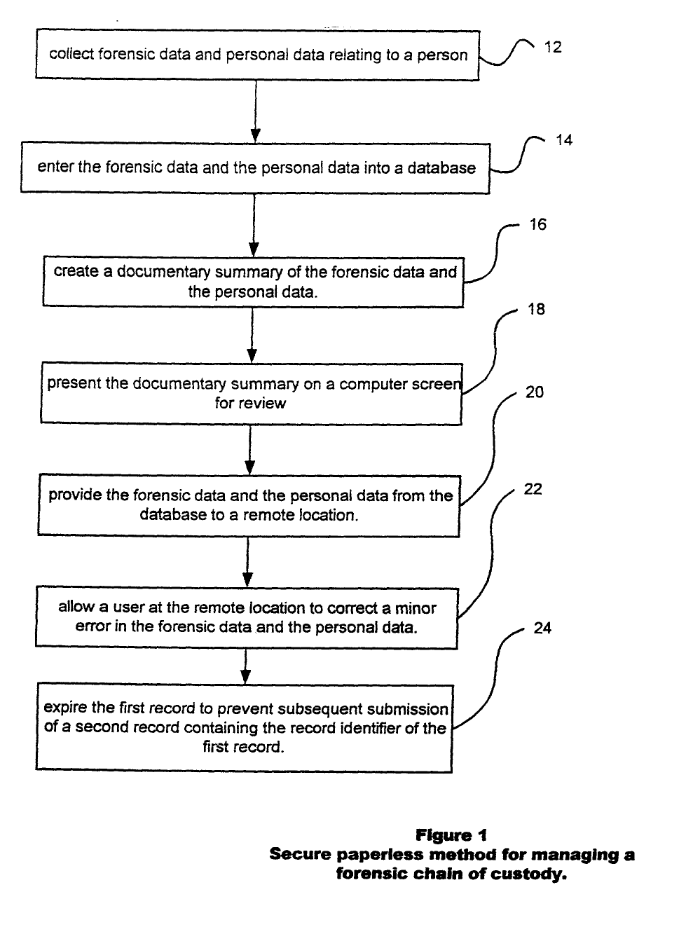

FIG. 1 is a flowchart representing a secure paperless method for managing a forensic chain of custody. The method comprises a step 12 of collecting forensic data and personal data relating to a person, a step 14 of entering the forensic data and the personal data into a database, a step 16 of creating a documentary summary of the forensic data and the personal data, a step 18 of presenting the documentary summary on a computer screen for review, a step 20 of providing the forensic data and the personal data from the database to a remote location, a step 22 of allowing a user at the remote location may correct a minor error in the forensic data and the personal data, and a steop 24 of expiring the first record to prevent subsequent submission of a second record containing the record identifier of the first record.

In accordance with one embodiment of the present invention, the step 12 of collecting forensic data and personal data relating to a person includes obtaining a forensic specimen sample of bodily material, such pre-employment urine testing or pre-employment blood testing; for example, the forensic specimen sample of bodily material is a blood sample. If desired, the forensic specimen sample of bodily material may be urine, skin or other tissue, bone marrow, or hair. The step 12 of collecting forensic data and personal data relating to a person also includes obtaining information from the person such as the person's full name, address, social security number, telephone number, employer, medical history, and family history. The step 12 of collecting forensic data and personal data relating to a person may also include obtaining biometric information such as a fingerprint, a voiceprint, or a photograph of the person's face.

The bodily material being tested may contain evidence that may be useful in a judicial or employment decision, but might not contain individually identifiable data. For example, before genetic testing was developed, blood could be tested for blood type, but no test existed that could match a blood sample to its donor. To match the bodily material to its donor, in accordance with one embodiment of the present invention, the personal data further includes a biometric signature (i.e., biometric information that may be regarded as a biometric signature). The biometric signature is, for example, a fingerprint.

If desired, the biometric signature may be a voiceprint, a DNA sample, or a retinal scan, or any combination thereof. A biometric signature may be obtained from and the person to whom the forensic data and the personal data pertain. If desired, a biometric signature may also (or alternatively) be obtained from a data collector, for example a nurse or attendant who can attest to the veracity of the data collection.

The step 14 of entering the forensic data and the personal data into a database includes typing obtained information into a computer storage medium via a user interface. The user interface may be, for example, a keyboard. If desired, the user interface may be a voice recorder or touch screen. The step of entering the forensic data and the personal data into a database may include using a device, such as a pocket Pc, a palm pilot, and a tablet pc. Entering the forensic data and the personal data may also (or alternatively) be accomplished wirelessly.

The step 16 of creating a documentary summary of the forensic data and the personal data includes, for example, merely confirming that the data has been recognized as data. If desired, this step may be replaced with the creating of a more detailed documentary summary.

As shown in FIG. 1, the method also includes a step 18 of presenting the documentary summary on a computer screen for review. Presenting the documentary summary allows a user to correct any incorrectly provided information. Presenting the documentary summary also allows the user to cancel or abort data entry. For example, the method includes a step of generating a PDF file containing the documentary summary. The PDF file allows the documentary summary to be reprinted if an accident destroys or adversely affects the readability of the documentary summary. The PDF file also allows the documentary summary to be transmitted as an email attachment. Transmitting as an email (i.e., emailing) is only one action that may be taken; if desired, the action may be saving, printing, and/or emailing. Other actions may supplement or be substituted for any of the above-stated actions.

As further shown in FIG. 1, the method also includes a step 20 of providing (i.e., submitting) the forensic data and the personal data from the database to a remote location. In other words, the method also includes a step of submitting a first record containing forensic data and personal data relating to the person and a record identifier. For example, the forensic data and the personal data may be transmitted to a data warehouse, to a physician, to a laboratory, to a central office, or to a government agency such as a disease-control center.

In accordance with one embodiment of the present invention, a database located at the remote location may store the forensic data, the personal data, or both the forensic data and the personal data, or any set or subset of such data. The data may be stored in the format in which it is transmitted, such as a PDF file, or may be converted to another format, such as an OBDC database. Providing the forensic data and the personal data may also (or alternatively) be accomplished wirelessly.

In accordance with one embodiment of the present invention, the step of submitting the first record includes a step of securing the first record by encrypting the forensic data and the personal data into a database. If desired, the step of encrypting may include a step of using Microsoft encryption.

In accordance with one embodiment of the present invention, the step of submitting the first record includes allowing a user to enter data on a device that is selected from a group consisting of a palm pilot, pocket pc, and tablet pc. (This is to be distinguished from the step of collecting data using such a device.) For example, forensic data and personal data may be collected on a palm pilot, transferred to a personal computer, and then transmitted over the Internet to the remote location.

As further shown in FIG. 1, the method also includes a step 22 of allowing a user at the remote location to correct a minor error in the forensic data and the personal data. For example, a laboratory technician or a physician at the remote location may recognize that a name, address, or other personal data includes a misspelling or was otherwise mis-entered, and can correct such misspelling or mis-entering. Allowing the laboratory technician or the physician can prevent subsequent confusion or misattribution of the forensic data to a person other than the person to whom the forensic data properly pertams.

In accordance with one embodiment of the present invention, the method also includes a step 24 of expiring the first record to prevent subsequent submission of a second record containing the record identifier of the first record. (This step may be particularly important when used in conjunction with the embodiment, described below, in which a browser has a “Back” button.) Substantial errors may thus be avoided, as each record that is submitted may be assigned a unique record identifier. There is very little opportunity for a subsequent record to be submitted under a record identifier that is also assigned to a previously entered record.

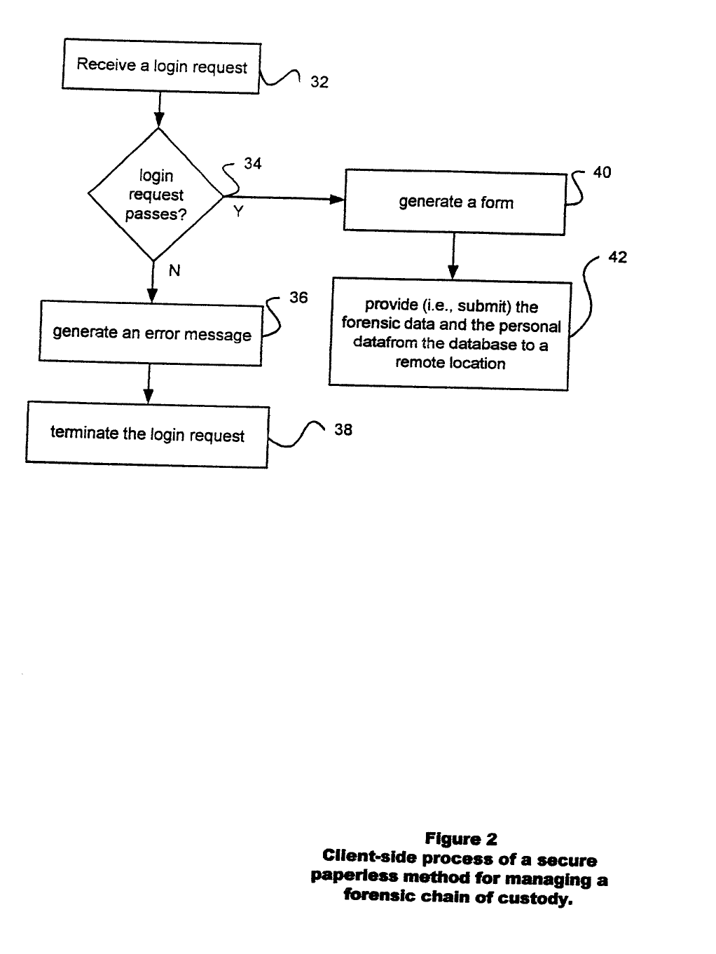

FIG. 2 is a flowchart representing a client-side process of a secure paperless method for managing a forensic chain of custody, in accordance with one embodiment of the present invention. The process begins at step 32, in which a login request is received. The login request includes, for example, receiving a username and a password, and optionally receiving client address or caller-ID verification, from a user interface.

At step 34, a determination is made whether the login request passes or fails. If the login request fails, then at step 36 an error message is generated, and at step 38 the login request is terminated.

If at step 34 the determination is made that the login request passes, then at step 40 a form is generated. The form allows a user (i.e., a data collector) to collect forensic data and personal data relating to a person. At step 42, after the user completes the form, the forensic data and the personal data contained within the form are provided (i.e., submitted) from the database to a remote location.

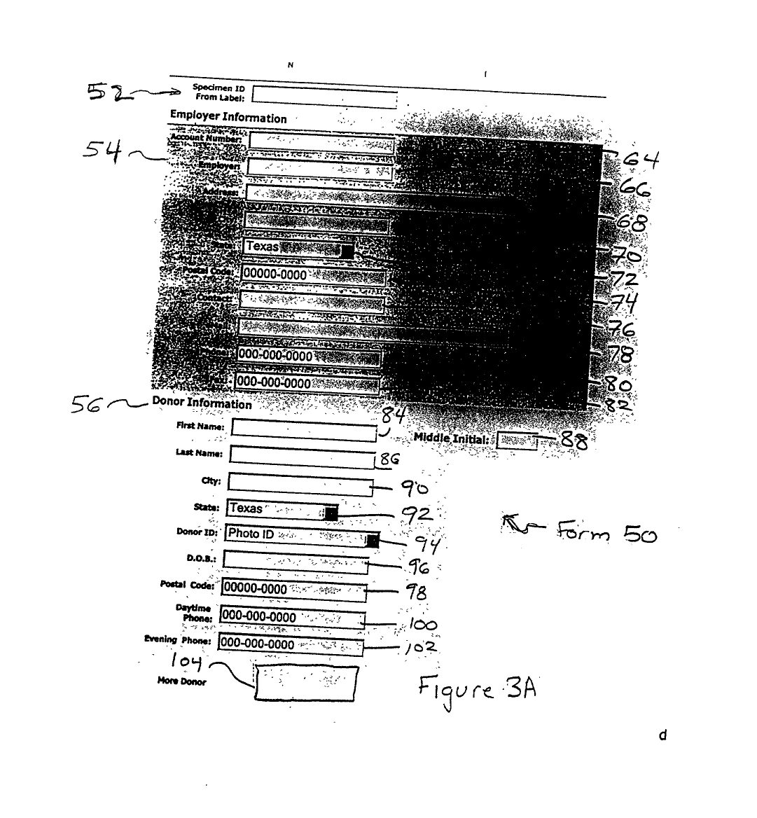

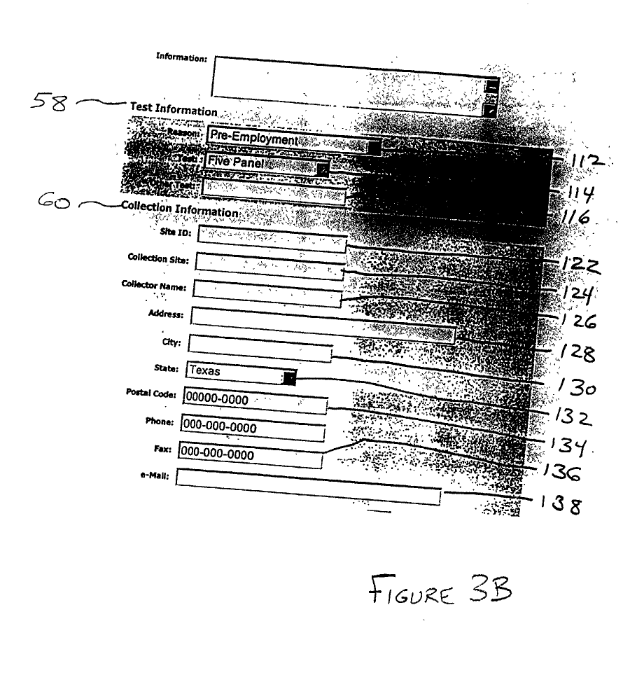

FIG. 3A and FIG. 3B are a representation of a form 50 that may be presented to a user within the client-side process of FIG. 2. The form 50 has several sections, including a specimen ID from Label field 52, an employer information section 54, a donor information section 56, a test information section 58, and a collection information field 60.

The specimen ID from Label field 52 may be used to protect against potential confusion among persons having similar names. A person may be required to donate several samples over a period of time; where a particular employer requires an donor to provide multiple samples at different points in time, or multiple types of fluid samples or tissue samples, the specimen ID from Label field 52 may also be used to distinguish the various samples even where all other forensic data and personal data remain identical among the various samples.

The employer information section 54 contains an account number field 64, an employer field 66, an employer address field 68, an employer city field 70, an employer state field 72, an employer postal code field 74, an employer contact field 76, an employer email field 78, an employer phone field 80, and an employer fax field 82. Other employer information may optionally be included as well. Employer information may be used, for example, to verify employer identity. Verifying employer identity may be required before allowing a user to access test results over the Internet. Employer information may be used to mail test results (or a documentary summary conclusion) to an employer.

The employer information section 54 may also be used to control the flow of information. For example, if an employer requests that an employee undergo testing for illegal drugs, and in an unrelated matter the employee is also a party to litigation (such as a paternity suit) in which forensic testing of the donor is necessary to resolve the litigation, results of some tests may be made available to the employer while results of other tests may be made available to the litigants. Privacy regulations and disclosure requirements may thus be implemented efficiently.

The donor information section 56 contains a donor first name field 84, a donor last name field 86, a donor middle initial field 88, a donor city field 90, a donor state field 92, a donor ID field 94, a donor D.O.B. (date of birth) field 96, a donor postal code field 98, a donor daytime phone 100, a donor evening phone field 102, and a more donor information field 104. Other donor information may optionally be included as well; for example, a list of donor allergies, or a complete donor medical history, may optionally be provided.

Such complete donor medical history may be used to explain test results that might otherwise appear incriminating to the donor. In some cases, a data collector might fail to obtain all necessary personal information from a donor. In such cases, an analyst might still be able to match a sample to a donor if the information that is obtained is sufficiently unique to the donor.

The test information section 58 contains a reason field 112, a test field 114, and an “other test” field 116. The information collected using the donor information section 56 of the form of FIG. 3A and FIG. 3B is included within the forensic data and personal data relating to a person. Maintaining information about the tests that have been performed on a particular donor enables subsequent review and evaluation of patterns of the donor's forensic history. Determinations may be made whether additional tests need to be performed.

The collection information section 60 contains a site ID field 122, a collection site field 124, a collector name site 126, a collection address field 128, a collection city field 130, a collection state field 132, a collection postal code field 134, a collection fax 136, and a collection email 138. The collection information section 60 may be regarded as a signature of the data collector. If desired, a biometric signature (i.e., biometric information that may be regarded as a biometric signature) can replace or supplement forms containing the collection information section 60.

The collection information section 60 may be used, for example, to gain an understanding of patterns within a collection site. For example, if a collection site employs poorly trained staff, patterns may emerge among forensic samples obtained at the collection site. The form 50 also includes a “Click Here to Print COC” field. The form may be printed as many times as a user desires.

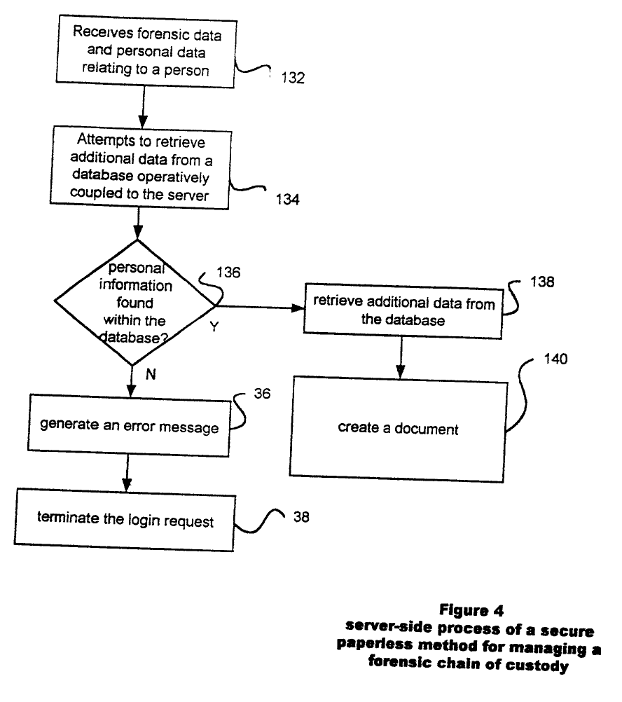

FIG. 4 is a flowchart representing a server-side process of a secure paperless method for managing a forensic chain of custody, in accordance with one embodiment of the present invention. The process begins at step 132, in which the server receives forensic data and personal data relating to a person. At step 134, the server attempts to retrieve additional data from a database operatively coupled to the server. At step 136, a determination is made whether at least one record matching the personal information is found within the database. If such a record is found, then at step 138 additional data are retrieved from the database, and at step 140, a document is created. If no such record is found, then the process terminates, optionally creating a log entry.

The document is, for example, an HTML (hypertext markup language) document representing a chain of custody for a forensic specimen sample of bodily material. If desired, the HTML document may be replaced with a PDF (portable document format) document. The document may be printed, compressed, encrypted, stored to a data storage medium, and/or emailed.

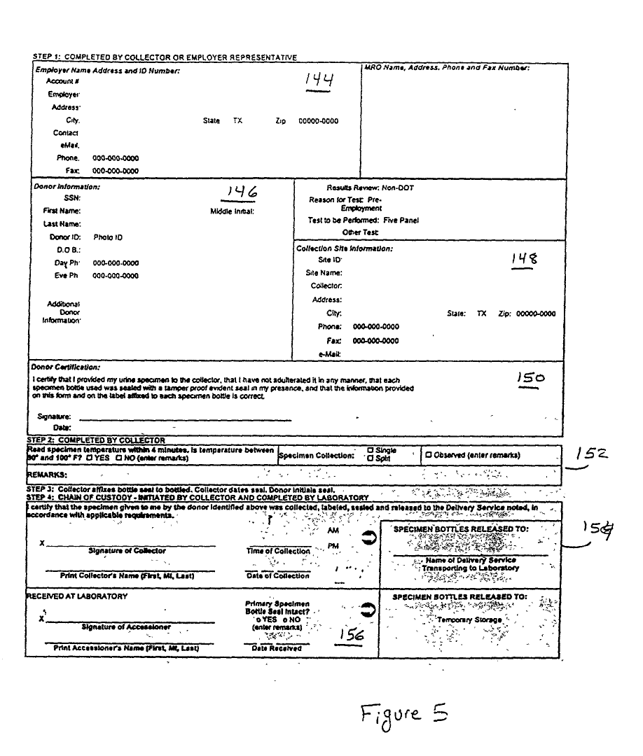

FIG. 5 is a representation of a documentary summary that may be presented to a user within the server-side process of FIG. 4. FIG. 5 includes various employer fields 144, various donor fields 146, various collection site information fields 148, a donor certification field 150, various collector-determined information fields 152, and an attestation section 154 including both collector attestation and donor attestation. A chain of custody record 156 indicating to whom specimen bottles are released is also provided

The documentary summary may be reprinted as often as desired, and may be presented as an HTML document, as a PDF document, or in other document formats. The documentary summary may also be encrypted, and may be emailed to a court or to an employer. If a printed documentary summary is lost or damaged, another copy may easily be printed. Digital certificates, digital signatures, and one-way hash functions may be used to verify authenticity.

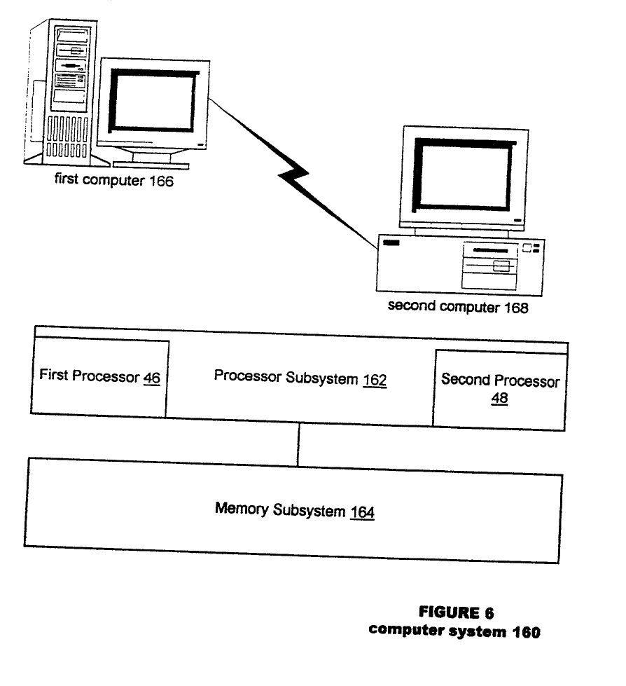

FIG. 6 is a schematic drawing depicting a computer system 160, in accordance with one embodiment of the present invention. In accordance with the embodiment of the present invention depicted in FIG. 6, the computer system 160 includes a processor subsystem 162 and a memory subsystem 164 coupled to the processor subsystem 162. The processor subsystem 162 is operative to execute instructions, and includes a first computer 166 at a data-collection site. The data-collection site may be, for example, a health-care facility operated by an employer. The data-collection site may be mobile testing facility operated by a health insurer, a criminal detention center; or a facility operated by an employee-screening enterprise. The “computer” may be any circuit, device, logic gate, sensor, detector, or data entry unit.

Although in some embodiments of the present invention the processor subsystem 162 includes only a single computer, the embodiment depicted in FIG. 6 includes a first computer 166 and a second computer 168 coupled to the first computer 166 via the Internet. For example, the first computer 166 may be an application service provider (ASP) process executing on a server platform of a storage area network, while the second computer 168 may be a client desktop computer residing in a laboratory, office, or customer facility. If desired, the computer system 160 of FIG. 6 may be replaced with a computer system in which the processor subsystem 160 is contained within a first computer and a second computer coupled to the first computer via a computer network.

In accordance with a first embodiment of the present invention, the processor subsystem 162 includes a first processor 46 residing within the first computer 166, and a second processor 48 residing within the second computer 168. The application service provider (ASP) process includes a first portion executed on the first processor 46 residing within the first computer 166, and a second portion executing on the second processor 48 residing within the second computer 168.

In accordance with a second embodiment of the present invention, the processor subsystem 162 includes only the first processor 46 residing within the first computer 166; the second computer 168 is replaced with a network device other than a processor, for example a printer or monitor. The network device may include a graphic processor or other device that performs some processing functions, but need not perform any portion of the application service provider process.

In accordance with a third embodiment of the present invention, the processor subsystem 162 includes only the second processor 48 residing within the second computer 168. The second processor 48 executes all of the instructions associated with the process.

In accordance with a fourth embodiment of the present invention, the processor subsystem 162 includes a only the second processor 48 residing within the second computer 168, but the first computer 166 is replaced with an input/output device that provides a set of instructions to the second computer 168 when commanded to do so. The entire application service provider (ASP) process is executed within the second computer 168.

The memory subsystem 164 is coupled to the processor subsystem, and contains a set of instructions. When executed in the processor subsystem 162, the set of instructions causes the processor subsystem 162 to perform a step of collecting forensic data and personal data relating to a person, a step of entering the forensic data and the personal data into a database, and a step of creating a documentary summary of the forensic data and the personal data.

In the first embodiment of the present invention described in reference to FIG. 6, in which the second computer 168 is coupled to the first computer 166 via the Internet, the memory subsystem 164 includes a first memory residing within the first computer 166 and a second memory residing within the second computer 168. For example, a first portion of the set of instructions corresponding to the application service provider (ASP) process resides within (and executing on) the first computer 166 (i.e., the server platform of the storage area network). A second portion of the set of instructions corresponding to the application service provider (ASP) process resides within (and executes on) the second computer 168 (i.e., the client desktop computer residing in a laboratory, office, or customer facility).

In the second embodiment of the present invention, described in reference to FIG. 6, in which the processor subsystem 162 includes only the first processor residing within the first computer 166, the memory subsystem 164 includes only a memory residing within the first computer 166. The network device that is substituted for the second computer 168 does not contain any portion of the memory subsystem 164.

In accordance with the third embodiment of the present invention described in reference to FIG. 6, in which the processor subsystem 162 includes a only the second processor residing within the second computer 168, the memory subsystem 164 includes only a memory residing within the second computer 168.

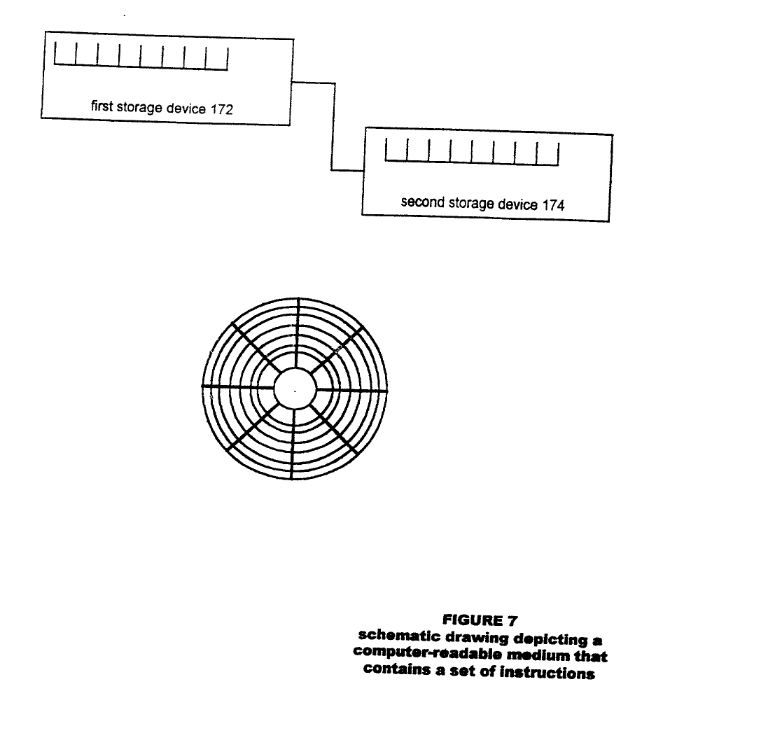

FIG. 7 is a schematic drawing depicting a computer-readable medium of the memory subsystem 164 that contains a set of instructions, in accordance with a first embodiment of the present invention. When the set of instructions are executed in a processor system, the set of instructions causes the processor system to perform a step of collecting forensic data and personal data relating to a person, a step of entering the forensic data and the personal data into a database, and a step of creating a documentary summary of the forensic data and the personal data.

As shown in FIG. 7, the computer-readable medium of the memory subsystem 164 includes a first storage device 172 and a second storage device 174 coupled to the first storage device 172 via the Internet. In accordance with a second embodiment of the present invention the computer-readable medium contains a first storage device 172 and a second storage device 174 coupled to the first storage device 172 via a computer network. In accordance with a third embodiment of the present invention, the computer-readable medium may be replaced with an alternate computer-readable medium that contains only a single storage device.

It should be understood that the invention is not limited by the specific embodiments described which are provided for exemplary purposes, to assist in the understanding of the invention. The implementation of other variations and modifications of the invention in its various aspects will be apparent to those of ordinary skill in the art; for example, the documentary summary may include charts and graphs representing numerical values provided by the test results as a percentage of predetermined “permissible” values. The step of providing (i.e., submitting) the forensic data and the personal data from the database to a remote location may be implemented as an 802.11x or Bluetooth wireless data link or encrypted over a CDMA modem link. It is therefore contemplated to cover by the present invention, any and all modifications, variations, or equivalents that fall within the spirit and scope of the basic underlying principles disclosed and claimed herein.

What is claimed is:

1 A secure paperless method for managing a forensic chain of custody comprising steps of:
collecting forensic data and personal data relating to a person; entering the forensic data and the personal data into a database; and
creating a documentary summary of the forensic data and the personal data.

2. The method of claim 1, further comprising a step of:
presenting the documentary summary on a computer screen for review.

3. The method of claim 1, further comprising a step of:
generating a PDF file containing the documentary summary.

4. The method of claim 1, further comprising a step of:
allowing a user to perform an action selected from a group of actions consisting of saving, printing, and emailing.

5. The method of claim 1, further comprising a step of:
providing the forensic data and the personal data from the database to a remote location.

6. The method of claim 5, wherein the remote location is a laboratory.

7. The method of claim 5, wherein a user at the remote location may correct a minor error in the forensic data and the personal data.

8. The method of claim 5, further comprising steps of:
submitting a first record containing forensic data and personal data relating to the person and a record identifier.

9. The method of claim 8, further comprising steps of:
expiring the first record to prevent subsequent submission of a second record containing the record identifier of the first record.

10. The method of claim 8, wherein:
the step of submitting the first record includes allowing a user to enter data on a device that is selected from a group consisting of a palm pilot, pocket pc, and tablet pc.

11. The method of claim 8, wherein:
the first record further includes a biometric signature selected from a group consisting of a fingerprint, a voice print, a dna sample, and a retinal scan, and belonging to a user selected from a group consisting of the person and a collector.

12. The method of claim 8, wherein:
the step of submitting the first record includes a step of securing the first record by encrypting the forensic data and the personal data into a database.

13. The method of claim 8, wherein:
The step of encrypting includes a step of using Microsoft encryption.

14. The method of claim 1, wherein:
the forensic data includes testing data selected from a group consisting of a pre-employment urine testing and pre-employment blood testing.

15. The method of claim 1, wherein the step of entering the forensic data and the personal data into a database includes a step of using a device selected from a group consisting of a pocket pc, a palm pilot, and a tablet pc.

16. The method of claim 1, wherein the step of entering the forensic data and the personal data into a database includes a step of entering data wirelessly.

17 A computer system for managing a forensic chain of custody comprising:
a processor subsystem operative to execute instructions; and
a memory subsystem, coupled to the processor subsystem, containing a set of instructions that when executed in the processor system causes the processor system to perform steps of:
collecting forensic data and personal data relating to a person;
entering the forensic data and the personal data into a database; and
creating a documentary summary of the forensic data and the personal data.

18. The computer system of claim 17, wherein the processor subsystem is contained within a single computer.

19. The computer system of claim 17, wherein the processor subsystem is contained within a first computer and a second computer coupled to the first computer via the Internet.

20. The computer system of claim 17, wherein the processor subsystem is contained within a first computer and a second computer coupled to the first computer via a computer network.

21 A computer-readable medium containing a set of instructions that when executed in a processor system causes the processor system to perform steps of:
collecting forensic data and personal data relating to a person;
entering the forensic data and the personal data into a database; and
creating a documentary summary of the forensic data and the personal data.

22 The computer-readable medium of claim 21 containing a single storage device.

23 The computer-readable medium of claim 21 containing a first storage device and a second storage device coupled to the first storage device via the Internet.

24 The computer-readable medium of claim 21 containing a first storage device and a second storage device coupled to the first storage device via a computer network.
